(19) United States
(12) Patent Application Publication
(10) Pub. No.: US 2003/0163388 A1
(43) Pub. Date: Aug. 28, 2003

(54) Self-service ordering and transaction processing terminal

(75) Inventor: Thomas F. Beane, Little Rock, AR (US)

Correspondence Address: Mark Rogers, Speed & Rogers, P.A., Suite 125, 1701 Centerview, Little Rock, AR, 72211, US

(73) Assignee: Viamation LLC, Little Rock, AR

(21) Appl. No.: 10/372,525

(22) Filed: Feb. 21, 2003

Related U.S. Application Data
(60) Provisional application No. 60/359,004, filed on Feb. 22, 2002.

(51) Int. Cl. G06F 17/60

(52) U.S. Cl. 705/26

(57) ABSTRACT

A self-service order-processing terminal is disclosed having a housing and having a display, coin dispenser, bill dispenser, and printer disposed in the housing. Separate locking means with different unlocking means are provided for accessing the coin dispenser, bill dispenser, and printer. The terminal has a database for storing customer order data and automatically sends and receives customer order data to and from a remote database. Diagnostic software runs checks and, if warranted, generates and sends error reports. The terminal is coupled with a display disposed in a food preparation area to notify employees of problems, such the need to replenish currency or printer paper. The terminal stores data relating to a customer's order and, when the customer later enters an identification code, the terminal displays past orders in color coded fashion, allowing the customer to quickly place the same order, if desired.

This application claims priority from U.S. Provisional Patent Application Serial No. 60/359,004, filed on Feb. 22, 2002.

### BACKGROUND OF THE INVENTION

This invention relates to self-service ordering terminals and, more particularly, to self-service ordering terminals for restaurants.

Studies have shown that quick service restaurant customers' priorities, in order, are taste, order accuracy, freshness, and speed of service. Further, quick service restaurant owners, employees, and customers are desirous of anything that can expedite and simplify the ordering and transaction payment process. An employee's interaction with the customer directly effects order accuracy and speed of service. Customers are well aware of the significant number of times that orders are not correct and of the fact that “quick” often does not describe the speed of service. The problems inherent in utilizing low-wage workers in quick service restaurants are also well documented. The public sometimes has a lack of confidence or trust in a quick service restaurant employee. Studies show that the customer does not want to interact with the employee, considering them rude, inattentive, and lazy. Conversely, the last place a quick service restaurant employee wants to work is on the counter taking orders because the customers often treat them badly and look down up them. It is no wonder that employee turnover in such restaurants averages 300% annually.

Language barriers can also be a problem in at least a couple of ways. First, a potential customer who may speak little or no English may be hesitant to visit a restaurant because of a language barrier or, conversely, may be more likely to visit a restaurant at which he or she may place an order in a language other than English. Second, because a quick service restaurant may employ a large number of low wage employees and may suffer from a high employee turnover rate, it may be difficult at times to consistently staff shifts at a quick service restaurant without relying in part on employees who may speak little or no English or who may not be particularly gifted at communicating with customers.

Loss of cash is also a serious concern for quick service restaurant owners and can take several forms. Studies have found that a typical employee of a quick service restaurant steals an average of $218 annually. Robbery by non-employees also continues to be a threat to all retail establishments. Further, counterfeiting of bills is a growing problem.

It is known to use a self-service order-processing terminal in a quick service restaurant. Such terminals offer a number of advantages. The American public has been conditioned to receive most of its information via television. Further, the public has also become accustomed to self-service terminals from pay-at-the-pump to information kiosks to automatic bank tellers. Accordingly, using a self-service order-processing terminal in a quick service restaurant should be readily accepted by the public and can offer a number of advantages. For example, a self-service terminal can combine a high-quality audio-visual presentation that utilizes practically all the human senses to motivate and influence a customer to select products and services. It can provide an automatic, uniform, and efficient means for offering and promoting products and services. It can reduce the overall cost of operations by reducing the number of personnel needed to staff any particular shift. Using self-service terminals can also reduce the number of work positions an employee must learn and can reduce the number of employees who must perform the disliked job of order taking. Self-service terminals can reduce order errors by allowing the customer to enter the order exactly as they want without the potential of misinterpretation as is now when communicating with an employee. Self-service terminals can reduce language barrier problems by providing information in any number of different languages and by reducing the number of employees needed in any particular shift having some degree of English language proficiency. Self-service terminals may also reduce employee theft by reducing the number of employees with access to cash and may reduce robberies by keeping cash out of sight in a locked terminal.

Although using self-service terminals at a restaurant can offer many advantages, such usage still suffers from a number of disadvantages. For example, customers can quickly become discouraged or frustrated if order entry involves too many steps, takes too much time, or requires too much reading, listening, searching, or thought. Similarly, presenting all possible ordering options to each customer may undesirably slow the ordering process and may discourage or frustrate the customer. Further, any number of mechanical or maintenance problems may lead to order errors, transaction processing errors, and terminal down-time, all of which may lead to customer and employee dissatisfaction, particularly if any such problems occur during a high traffic time. For example, if a terminal unexpectedly runs out of any type of bill or coin for making change, the entire terminal must typically be immediately shut down or disabled until the bills or coins can be replenished. If any type of bill or coin dispenser for making change malfunctions, the entire terminal must typically be immediately shut down or disabled, until the terminal may be repaired. Similarly, any number of hardware or software related problems may cause a terminal to suddenly and unexpected malfunction or fail to function. Further still, maintenance and repair may be undesirably time-consuming. For example, maintenance and support of such terminals will often require two trips to a site, the first for diagnosis, and if the requisite repair parts were not brought along by the repair technician, a second trip to replace the malfunctioning subassembly.

### SUMMARY OF THE INVENTION

It is therefore an object of the present invention to a self-service order processing terminal and a method of using the same that offers fast, accurate order placement.

It is a further object of the present invention to provide a terminal and method of the above type that allows one or two keystroke ordering.

It is a further object of the present invention to a terminal and method of the above type that provides color-coded ordering options.

It is a further object of the present invention to provide a terminal and method of the above type that provides for 15-second order placement.

It is a still further object of the present invention to provide a terminal and method of the above type provides different levels of security for accessing different components of the terminal.

It is a still further object of the present invention to provide a terminal and method of the above type that allows great flexibility in granting different levels of access to different employees.

It is a still further object of the present invention to provide a terminal and method of the above type that automatically provides low currency or paper warnings to employees working in areas away from the terminal.

It is a still further object of the present invention to provide a terminal and method of the above type that automatically runs self-diagnostic checks and automatically sends error reports to remote receivers.

It is a still further object of the present invention to provide a terminal and method of the above type that reduces repair and maintenance costs.

It is a still further object of the present invention to provide a terminal and method of the above type that automatically sends and receives updated customer order data from a plurality of restaurants.

It is a still further object of the present invention to provide a terminal and method of the above type that allows for one or two keystroke ordering at different terminals disposed in different restaurants.

It is a still further object of the present invention to provide a terminal and method of the above type that stores and retrieves multiple past customer orders and displays such multiple orders in color coded fashion.

It is a still further object of the present invention to provide a terminal and method of the above type that reduces ordering and payment transaction time for repeat customers by recording their product selections in order groups.

It is a still further object of the present invention to provide a terminal and method of the above type that allows the customer to pick a color-coded order group to place the order instead of reentering each item on subsequent visits.

It is a still further object of the present invention to provide a terminal and method of the above type that allows the customer to automatically pay if the method of self-identification is selected as the method of payment.

It is a still further object of the present invention to provide a terminal and method of the above type that expedites order fulfillment.

It is a still further object of the present invention to provide a terminal and method of the above type that reduces errors in returning the correct amount of change to the customer.

It is a still further object of the present invention to provide a terminal and method of the above type that allows a customer to interact with a high-tech terminal rather than with an unmotivated, inattentive employee.

It is a still further object of the present invention to provide a terminal and method of the above type that provides for on-the-spot payment for products or services by cash, whether coins or bills; or by credit or debit method, whether by means of magnetic-stripe card, smart card, radio-frequency-identification encoded device, or bar-coded label.

It is a still further object of the present invention to provide a terminal and method of the above type that to provide for automated teller machine cash back convenience either during the food ordering process or independently.

It is a still further object of the present invention to provide a terminal and method of the above type that allows for the updating of each terminal automatically by electronic transfer of products and services data thereby providing franchise-wide uniformity.

It is a still further object of the present invention to provide a terminal and method of the above type that Utilizes a self-diagnostic program in each terminal to identify, assess, and take action based on the problem identified.

It is a still further object of the present invention to provide a terminal and method of the above type that Reports malfunctions or service problems via the order-picking screen to immediately alert an employee of a problem.

It is a still further object of the present invention to provide a terminal and method of the above type that automatically contacts a central location for action, for those events that cannot be remedied by on-site action.

It is a still further object of the present invention to provide a terminal and method of the above type that Utilizes built-in diagnostic programs to allow for on-site testing of all subassemblies by an employee.

It is a still further object of the present invention to provide a terminal and method of the above type that allows the terminal to continue working in a degraded operating capacity. For example, if nickels are not available, the terminal will print out a second receipt directing to and providing a coupon for the customer to receive missing change from the order pick-up counter.

It is a still further object of the present invention to provide a terminal and method of the above type that resists counterfeiting by subjecting each bill to two types of tests: optical and magnetic.

It is a still further object of the present invention to provide a terminal and method of the above type that reduces labor by automatically handling credit and debit transactions.

It is a still further object of the present invention to provide a terminal and method of the above type that displays on the screen all elements needed by a customer in order to make an informed selection: graphic of the menu item, price, name, quantity, and relative size.

It is a still further object of the present invention to provide a terminal and method of the above type that utilizes the “ATM effect” in which 25% more is spent by customer at that location when they have access to their cash.

It is a still further object of the present invention to provide a terminal and method of the above type that allows the restaurant owner to collect ATM transaction fees on cash back option when the customer uses the inherent ATM capability of the system.

It is a still further object of the present invention to provide a terminal and method of the above type that allows for the electronic capture of a customer's signature as may be required for payment transaction processing.

It is a still further object of the present invention to provide a terminal and method of the above type that allows for the electronic capture of the customer's voice commands and personal graphic for customer data association.

It is a still further object of the present invention to provide a terminal and method of the above type that allows for the electronic capture of the customer's photo to subsequently match the customer to their order when delivering the product.

It is a still further object of the present invention to provide a terminal and method of the above type that provides a bar-code reader to capture data from bar coded cards or coupons.

It is a still further object of the present invention to provide a terminal and method of the above type that simplifies the installation and system integration into a quick service restaurant's current order processing system by being Plug-and-Play compatible with cash register type systems currently in use.

Toward the fulfillment of these and other objects and advantages, the self-service order-processing terminal of the present invention has a housing and has a display, coin dispenser, bill dispenser, and printer disposed in the housing. Separate locking means with different unlocking means are provided for accessing the coin dispenser, bill dispenser, and printer. The terminal has a database for storing customer order data and automatically sends and receives customer order data to and from a remote database. Diagnostic software runs checks and, if warranted, generates and sends error reports. The terminal is coupled with a display disposed in a food preparation area to notify employees of problems, such as the need to replenish currency or printer paper. The terminal stores data relating to a customer's order and, when the customer later enters an identification code, the terminal displays past orders in color coded fashion, allowing the customer to quickly place the same order, if desired.

### BRIEF DESCRIPTION OF THE DRAWINGS

The above brief description, as well as further objects, features and advantages of the present invention will be more fully appreciated by reference to the following detailed description of the presently preferred but nonetheless illustrative embodiments in accordance with the present invention when taken in conjunction with the accompanying drawings, wherein:

FIG. 1 is a front elevation view of a terminal of the present invention;

FIG. 2 is a partially cutaway, rear elevation view of a terminal of the present invention;

FIG. 3 is a flow chart showing representative operations of a terminal of the present invention; and

FIG. 4 is a schematic representation of a multi-restaurant system using terminals of the present invention.

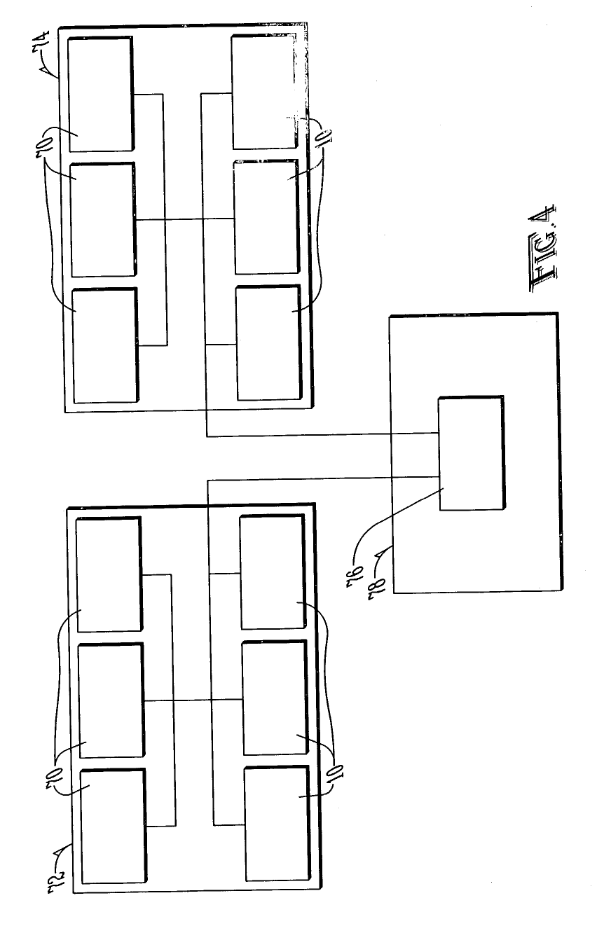

### DETAILED DESCRIPTION OF THE PREFERRED EMBODIMENT

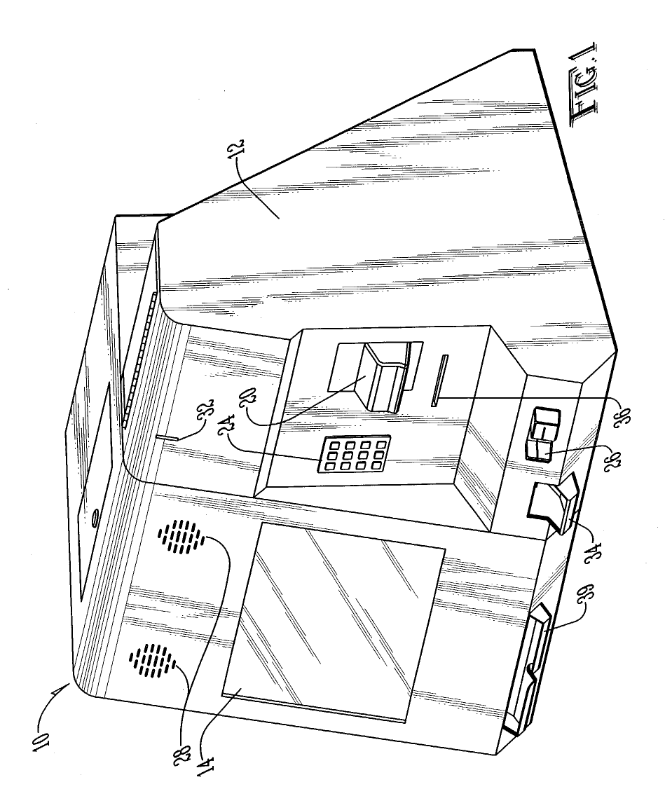

Referring to FIG. 1, the reference numeral 10 refers in general to a self-service, order-processing terminal of the present invention. The terminal 10 has a housing 12 and a combination of other components that are disposed within the housing 12. The components are selected as desired to customize the terminal 10 and provide the desired functionality. A few common, representative components include a display 14, preferably having a touch screen overlay, a computer 16, a coin acceptor and dispenser 18, a bill verifier 20, a bill dispenser 22, a pin pad 24, a magnetic stripe reader 26, a smart-card reader, a radio frequency identifier, a bar code reader, a modem, a network interface, a speaker 28, a microphone, an electronic camera, a signature capture pad, and a printer 30. It is understood that these components may be used in any number of combinations, that other components may be used as well, and that some components may be disposed in places other than the housing 12.

The housing 12 is a basic cabinet made from steel panels. These panels will allow tailoring of the exterior of the box to customer requirements with silk-screen overlays. Different quick service restaurant chains can therefore have a distinctive exterior with their own signage while the basic box is unchanged. The box and internal components will be similar for all customers. The housing 12 is preferably a UL-291 Business Hours rated cabinet. The terminal 10 will also comply with Federal ADA requirements. The terminal 10 can be provided as either free standing or counter mounted. The terminal 10 will be secured to the floor with a security rated chain or cable. The cabinet may be equipped with a break-in detection alarm. Access panels of the cabinet are locked with a key tumbler.

The terminal 10 may be disposed in any number of locations on and off-premises, including but not limited to being located at a food service counter, at a drive through station, at a central location in a food court of a mall, and at various convenient locations disposed around an arena, stadium, or the like. Particularly in a food court type setting, more than one restaurant may share a terminal. In this instance, an opening screen would allow the customer to select the restaurant at which the customer would like to place an order. Particularly in an arena or stadium type setting, the system may be set up to allow time shifting. In this instance, as a customer enters the arena, the customer might order and pay for all items that the customer will want during an event and might indicate a time or triggering event for when the customer wants to receive the item. For example, a customer might request certain items for pick-up or delivery at the end of an inning, quarter, half, or the like of a sporting event. Particularly in an arena type setting, the terminal 10 may also allow a customer to select a delivery option so that, perhaps for a surcharge, the ordered items will be delivered to the customer's assigned seat.

The following will identify preferred components in more detail, although it is understood that these preferred components are offered by way of example only and that the selection of which components to use and the selection of the specific individual components may vary wildly.

| | Presently preferred type and/or |
|---|---|
| Component | brand information |
| Computer | PC Celeron 866, 128 Mb, 20 Gb, 48 × CD, |
| | Floppy, SVGA w/8 Mb, 4 Serial, 1 Parallel, |
| | 4 USB, Sound, 1 PCI, Windows 2000 |
| Flat Panel Display & | ELO 1545L |
| Touch Screen | |
| Network Interface Card | 10/100 Base T |
| Modem | 56 k |
| Microphone | Generic |
| Speaker | Generic |
| Electronic Camera | Generic |
| Thermal Printer | Citizen 80 mm |
| Coin Acceptor & Dispenser | Coinco 9302-GX |
| Bill Verifier | Coinco Mag50B |
| Bill Dispenser | G & D ACD-3 |
| Pin Pad | Ingenico eN-Crypt 4200 |
| Magnetic-strip & | Axiohm 171TDA1 |
| Smart Card Reader | |
| Radio Frequency Identifier | Intersoft TR-ROI-OEM |
| Bar Code Reader | Metrologic MS951 |
| Signature Capture Pad | Ingenico eN-Touch 1000 |

A common configuration for a terminal 10 is disclosed in FIG. 1. The terminal 10 has a flat panel display 14 with a touch screen overlay. Speakers 28 are positioned over the display 14 to allow audiovisual communication. Different methods of accepting payment and making change are also provided. A slot 32 allows coins to be deposited into the coin acceptor and dispenser 18, and a tray 34 is provided for retaining coins dispensed by the coin dispenser 18. A bill verifier 20 and acceptor is also provided. A slot 36 is also provided so that the printer 30 may provide receipts printed on sheet material 37 such as on paper stored on a roll. A bill dispensing chute or tray 39 is also located under the display 14 for receiving bills from the bill dispenser 22 if the customer needs make change or uses the ATM function.

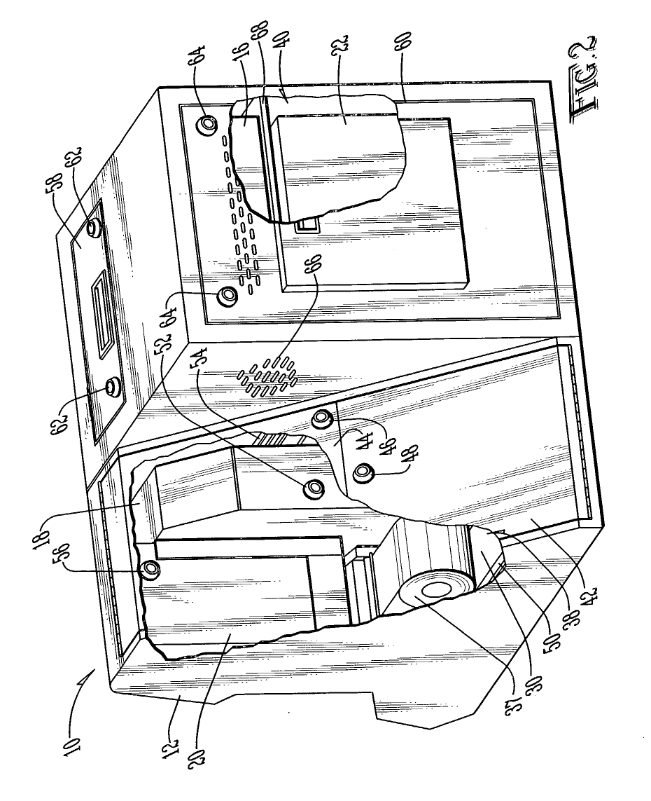

As best seen in FIG. 2, the components are arranged in the housing 12 so that different employees with different levels of authorization may be granted access to some components or subassemblies without being granted access to other components. The housing 12 is generally comprised of two compartments 38 and 40. The printer 30, coin acceptor and dispenser 18, and bill verifier 20 are disposed in one compartment 38 of the housing 12, and the display 14, speakers 28, computer 16, and bill dispenser 22 are disposed in the other compartment 40. Access to the first compartment 38 is through two doors 42 and 44 that are locked separately. One or more locks 46 are provided on the top door 44, and one or more locks 48 are provided on the bottom door 42. The locks 46 to the top door 44 are keyed different from the locks 48 on the bottom door 42. An employee may gain access to the printer 30 by unlocking and opening the bottom door 42. Virtually any employee may be give a key to the lock 48 of the bottom door 42 so that virtually any employee may replace printer 30 paper 37 without being provided access to money in the terminal 10. In fact, the bottom door 48 may or may not include a lock. The printer 30 is mounted on a rail 50 in a lower portion of the compartment 38 so that an employee may slide it forward into place for generating and providing receipts and slide it rearward to provide easy access to the printer 30 for maintenance and paper 37 replacement.

The coin acceptor and dispenser 18 has a lock 52 to restrict access to change held therein. This lock 52 is positioned at an upper portion of the coin acceptor and dispenser 18 so that it is not readily accessible when only the bottom door 42 is open. The coin acceptor and dispenser 18 lock 52 is keyed the same as the locks 46 on the upper door 44 so that an employee with a key to the locks 46 on the upper door 44 can also use that key to open the coin acceptor and dispenser 18. The coin acceptor and dispenser 18 is also mounted on a rail 54 in the compartment 38 so that an employee may slide it forward into place for accepting and dispensing coins and slide it rearward to provide easy access to the coin acceptor and dispenser 18 for maintenance and coin replenishment.

The bill verifier 20 is mounted in an upper portion of the compartment 38 and has a separate lock 56 that is keyed differently from the locks 46, 48, and 52 to the top and bottom doors 44 and 42 and coin acceptor and dispenser 18. The bill verifier 20 lock 56 is positioned at an upper portion of the bill verifier 20 so that it is not readily accessible when only the bottom door 42 is open. When this lock 56 is unlocked, a door pivots downward to provide access to bills stored in the bill verifier 20.

The other compartment 40 also has two doors 58 and 60 with each door having one or more locks 62 and 64 that are preferably keyed to require different keys to open the different doors 58 and 60. Small holes 66 may be provided in the sides of the housing 12 for cooling and ventilation purposes. It is preferred that the locks 64 to the lower door 60 of the second compartment 40 be keyed the same as the lock 56 on the bill verifier 20 so that the same key that opens the lock 56 on the bill verifier 20 will also open the locks 64 on the lower door 60 of the second compartment 40. The lock 62 to the upper door 58 may be keyed the same as the lower door 60 of the second compartment 40 if desired. The computer 16 is disposed in an upper portion of the compartment 40, resting on a shelf 68, and a bill dispenser 22 is disposed in a lower portion of the compartment 40. An emulator may be provided in the upper portion of the housing 40. The emulator is an electronic box located above the computer that links the computer to the Inter-register communication line of the restaurant's cash register system. The bill dispenser 22 is also mounted on a rail in the compartment 40 so that an employee may slide it forward into place for dispensing bills and slide it rearward to provide easy access to the bill dispenser 22 for maintenance and bill replenishment. An opening may be provided in the bottom of the housing 12 to allow access to telephone lines, power lines, LAN wiring, and other wiring, and the like. It is of course understood that any number of different conventional locking means and unlocking means may be used.

The self-service terminal 10 of the present invention is highly flexible and may be used, for example, for providing information by speech in multiple languages, sound, and video display, for printing documents, for recording customer activity by touch, voice, signature, and graphic, for accepting user input for ordering, for accepting actions required for payment thereof by cash or electronic debit or credit means, for providing ATM cash back services, and for recording and transferring electronic data between the system and other electronic devices and systems. The terminal 10 includes a flat panel display 14 for presenting information about the products or services sold, a touch screen for the customer to input selections, a printer 30 for delivering receipts and documents, a coin acceptor and dispenser 18 for accepting and paying out coins, a bill verifier 20 for verifying bills, a bill dispenser 22 for dispensing bills, a magnetic-stripe reader 26 for accepting magnetic-stripe encoded cards, a smart-card reader for accepting smart cards, a Radio-Frequency Identifier for accepting radio-frequency encoded devices, a bar-code reader for accepting bar-coded data, a signature-capture pad for capturing signatures, a pin pad 24 for manual entry of data, a modem for electronic telecommunications, a network interface card for communicating with other microprocessor systems, a speaker system for presenting sound and voice information, a microphone for recording sound, and an electronic camera for recording pictures. The operation of the terminal 10 is controlled by a microprocessor with mass storage electronically linked to the various devices listed above.

The terminal 10 is connected via the network interface to other computer systems 70 within the restaurant 72 and 74. Orders ready for processing are sent to the order-picking system. System status codes, system errors, and subsystem actual or predicted servicing conditions are automatically sent to the same order-picking system to alert restaurant employees for required action. Malfunctions beyond the service level capability of the restaurant 72 and 74 are automatically electronically transmitted to a computer 76 at a remote central location 78 for malfunction diagnosis and dispatch of repair personnel and parts. The computers 16 and 76 are equipped with remote access devices, such as modems, to allow such communication. System activity data is automatically electronically transmitted to a database in the computer 76 at the central location 78 for report generation and data analysis. The terminal 10 computer 16 also automatically connects with a computer 76 at a central location 78 for the downloading of new products and services, the modification of products and services, sending and receiving customer order data, and for application program upgrading.

The preferred embodiment of the invention is dedicated to the promotion and sale of food. The terminal 10 is operated from non-volatile memory, which is randomly accessible mass storage. The memory stores the operating program for the terminal 10; database of products and services; database of customer product selections by completed order; and a database of activity. Product data includes classification(s), nomenclature, speech, print, display, price, size, quantity, graphic, and availability. Customer data includes records maintained by unique identification code for a customer's product selections by completed order, voluntarily entered or automatically captured demographic information, date and time of orders, and the number of times an order has been selected. Other data includes system activity analysis, product offers, customer graphic, funds handled, and other activity-based information.

The system is used primarily for allowing customers to select and order food both visually and with voice assistance, pay for the order by cash, credit, or debit means, receive change back, receive ATM cash back services, print out a receipt of the order, electronically communicate credit or debit requests to transaction processors, electronically record customer touch, graphic, voice, and signature, electronically communicate the order to the order-processing system, and electronically communicate activity to other electronic devices or systems.

The system can expedite ordering and transaction processing for a repeat customer to a quick service restaurant's location 72 or 74. Since most customers basically order the same groups of products on return visits, those groups will be maintained in the system's databases for rapid recall and subsequent selection by the customer. For example, a customer eating lunch during the work day would order products collected as Group A. The same customer ordering breakfast on a weekend day would have those products collected as Group B. The same customer ordering dinner during the week would have those products collected as Group C. Each group is tied to the customer by a unique ID. Each group would also contain database information on the dates and times of orders. A customer returning on the next visit would first identify themselves by their unique ID, which could be a debit card account number, in which case the customer swipes his debit card through the magnetic-stripe card reader 26. Once identified, all prior customer orders by groups would be displayed on the ordering screen 14. As required, order groups could be arranged by time of day ordered and the most recently ordered. Groups could also be color coded for faster customer recognition of a group. For example, breakfast could have a background of blue, lunch green, and dinner yellow.

Once the customer recognizes the order he wants he touch selects that order. The system then gives the customer the option to place the order as is or modify the order. If modify is requested, the order is loaded as if the customer had selected each item individually and the customer then continues with a normal ordering process. If the customer selects as is, the thread would go immediately into the payment process. If the customer is paying with a debit or credit card, the thread will ask the customer if they want to pay with that card and if so will automatically complete the ordering and transaction processing. In this manner, a repeat customer could order and pay for a previously ordered group of products with only a one or two keystroke or touch selections completing the entire process in 15 seconds or less. It is understood that, as used herein, a keystroke may take any number of forms. For example, a keystroke may involve simply touching an appropriate area of a touch screen display, or it may involve touching or depressing an appropriate key or button of a keypad, keyboard, or the like.

The system can provide real-time customer order discounting schemes currently impractical in a manual order-taking environment, to increase sales. Currently quick service restaurants rely on the employee taking the order to ask a customer if they want to order something additional, such as to “super size” their selection. This method is relatively ineffective for two primary reasons. First, the employee hired does not have a sales background, was hired to be an order taker, and has little motivation or incentive to ask the customer questions which result in few positive results. Second, adding another item goes against human nature of the customer as, for example, they did not buy a dessert on their many previous visits so why would they want one now. However, since the system records specific customer ordering information, sales offers could be made to a customer using different criteria. First, the system will know a customer's food preferences, as that is what they have ordered in the past. Instead of each customer being asked the same question, offers would be based on a customer's prior selections. Second, the system will know when a customer has ordered specific product groups, as recited above. Product offers could be based on the frequency of an order. For example, if a customer has been ordering the same product group twice a month, can offer a price discount or perhaps another product item free if the customer places that order three times a month. In this manner the offer would not be going against human nature as they are ordering the same products each time. The behavior modification is to have them visit the quick service restaurant 72 or 74 more often in a given time period to be rewarded.

Another example of frequency discounting would be to offer a price discount or free product if a customer would buy a dinner meal that normally only buys a lunch or breakfast meal. Since the data to support this method is automatically collected and utilized, the costs to implement such a system are negligible making even a low customer acceptance rate successful. Additionally, activity data would record and show the success rates by types of offers for subsequent analysis to improve the acceptance rate of offers.

The system can provide real-time discounting for a group of customers. Based on a customer's self-identification code, that customer could be offered a discount because their code number is one of an identified group. For example, customers using a particular bank's debit card as their customer identification code could be offered price discounts or free products based on the bank's account number contained within the card's account number. The system can collect and record demographic and other data to coincide with a customer's ordering habits. The data could be collected automatically from a customer's means of self-identification or voluntarily by presenting customers with questions to be answered for free or with a product offer. Questions asked could be spread out over several customer trips. Questions asked could be based on what a customer ordered during a previous visit. For example, if they tried a new product the last visit, whether they bought the same product the next visit could be confirmed and recorded and if they did not order again could display a series of questions to ask the customer about the product. Other questions could relate to the service and food quality thereby replacing customer comment cards. Customers should be more inclined to make comments if the reporting process is simple and they know that the information will get to the right person. A customer dissatisfied for particular reasons could be given a price discount or a free product on their current order. Since this activity data would be recorded in their customer file, could prevent customer abuse of the concept by their repeatedly answering questions in a certain way just to get a discount.

The system is designed to take an electronic photo, or graphic, of a customer during the ordering process. This photo can be used by an employee to subsequently match the customer to his order when the employee is handing the order to the customer. This method could be used in place of or in conjunction with an order number printed on the customer's receipt. This method allows the appropriate matching of customers and orders regardless of the sequence in which an order is placed or processed.

The system is designed to be Plug-n-Play compatible with other systems currently in use in a quick service restaurant 72 or 74. It is a self-contained system that can directly replace a quick service restaurant's current cash register and order taking machine.

The system is designed to reduce employee theft by restricting access to cash. With this ordering and transaction processing system, fewer employees will be handling cash thereby reducing the potential for theft. Additionally, the system has separate physical security compartments for the printer 30, coins, and bills. While any employee could have access to the printer 30 to correct a paper jam for example, few employees would have access to the coins, and even fewer to the bills. Access to data and to maintenance and service screens of the system is granted via employee number and password. Access levels are granted by employee number, and the data and selections visible are also segregated in this manner. While the highest level of access could see data counters on coins and bills, the next lower level could only see those on coins. In this manner fewer employees would even know how much cash was in a system. With an automatic ordering process, employee discounting would be prevented in which an employee does not record all of the products ordered either to give a customer a free product or to keep the cash difference.

The system automatically connects on a periodic basis with a central computer 76 for the automatic download of product and system data changes and for the upload and download of system and customer activity data. In this manner, a franchiser can assure that all of their quick service restaurants 72 and 74 have up-to-date product offerings and that how a customer orders in one restaurant 72 or 74 is consistent throughout the franchise chain. Data collected is passed to the franchiser for subsequent analysis to improve sales or methods of operation. The system automatically connects as required to a central computer 76 to report system malfunctions. In this manner, the centralized maintenance facility will know in real-time, and probably before an employee realizes, that a malfunction has occurred. Subsequently the maintenance help desk can telephone call the quick service restaurant 72 or 74 to have an employee conduct a malfunction verification test to verify that the reported malfunction is actually occurring. After this diagnosis, repair personnel and required parts can be dispatched to the site for repairs.

The terminal 10 is designed to form a part of a touch screen driven order entry system. Quick service restaurant 72 or 74 customers make selections by touching the screen icons of menu buttons or food pictures. The menu screen has buttons for all of the categories such as specials, hamburgers, drinks, desserts, etc. This screen also shows a listing of everything ordered. Menu buttons and items available to be ordered change based on the time of day with a period of overlap between breakfast and lunch. When a menu button is selected, another screen comes up with pictures of the items in that category. All of the information needed by a customer in order to make a selection is included with the picture such as price, size, quantity, etc. If the item selected has condiments, another screen is displayed showing all condiments available with that selection. The customer can select either plain, with everything, or touch toggle each condiment yes or no as desired. The customer can also select a quantity with this screen.

If the item selected was a main menu item, a “thread” routine then guides the customer through complementary menu categories. For example, if a hamburger was chosen and the condiments selected, the next screen shows side orders, such as French fries and onion rings. The customer can then select size and quantity of a side item if they desire, or continue. The “thread” would then display screens for drinks and desserts in order before returning to the main screen. This routine provides a way to entice customers to order additional items while appearing to be the normal process, a non-threatening inducement to order additional food products. If when looking at their order list the customer sees that they have made an error, they can touch the item in the list and the system displays buttons to allow for the deletion or modification of the item. If modify is selected, the screen where that selection is made will be displayed. The customer can then change the selection to how they want it.

If the customer is returning to the same location and uses a means to self-identify, their prior order groups will be displayed. Self-identification occurs from a unique piece of identification that a customer uses for that purpose. For example, a driver's license with magnetic-stripe, a credit or debit card, a Radio-Frequency Identifier fob, a smart card, or a touch entered code. The customer first enters their identifier code into the system for example by swiping a magnetic-stripe card, etc. The system then displays some or all prior customer orders in order groups and color-code by group. The customer then only needs to select the order group that they want for this visit and the order is the automatically loaded. If customer order data has been uploaded to a remote database, such as on a main office 78 computer 76, and has been downloaded to databases in terminals 10 located in other restaurants 72 or 74, this expedited order processing feature may be used by a customer at more than one restaurant 72 or 74 location. In this instance, terminals 10 in a restaurant 72 or 74 may display customer order data gathered from more other restaurants 72 or 74.

During the ordering process, a customer's ordering record can be analyzed in real-time to provide automatic price discounts or free products. In this manner a customer can be enticed to frequent a location more often than they had or to purchase products for a meal that they ordinarily would not. This provides an automatic, real-time method to increase sales. During the entire ordering and transaction process, aural and visual cues are given to assist the customer in making selections. Speech is currently in English though Spanish, French, and any number of other languages could be added if desired by the quick service restaurant 72 or 74 owner. Once the order is entered, as they want it, the customer then selects the method of payment: cash or bankcard. For cash, the system has a bill verifier 20 and a coin acceptor and dispenser 18. Bills and coins are deposited until the amount required for payment is met or exceeded. If change back is due, coins will be dispensed from the coin acceptor and dispenser 18 and bills from the bill dispenser 22. If paying with a bankcard, the customer swipes the card through the card reader. The system then connects via telephone line to the appropriate bankcard-clearing house for settlement. If approved, the transaction is completed. If disapproved, the select method of payment screen is again displayed so that the customer can select to pay with either cash or another bankcard.

At the beginning of the ordering process, the customer can select an “ATM Only” transaction. Similarly, when a customer pays with a debit card, a screen comes up asking if they would like cash back. Either way, the customer can select the amount of cash back they desire. If cash back is requested, the customer then enters their security code on the pin pad 24. Once the card is approved, the bill dispenser 22 pays out the amount of currency requested. At the completion of the transaction, a thermal printer 30 prints a receipt with the customer's order number on it. The customer uses that number to claim their food when the order is ready.

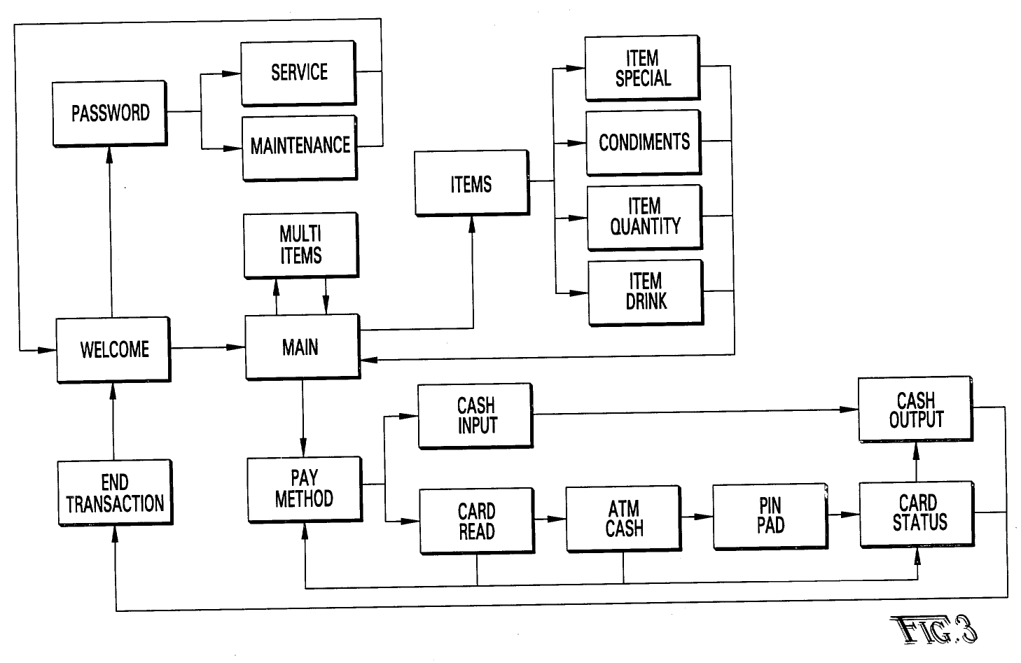

As best seen in FIG. 3, the following is a sample “thread” that a customer might go through in placing an order. The customer will initially encounter a Welcome screen that allows a customer to select dine-in or carryout, or go directly to ATM cash back. If ATM cash back is selected, the thread continues to Card Read. If the customer selects dine-in or carryout, the terminal records the customer preference and continues to Main. A small button is also available for employees that when selected disappears and shows another small button on a different area of the screen. If the second button is then selected before the timer fires, the thread will continue to Password. Alternatively, if the customer self-identifies as a reordering customer, the thread automatically selects that customer's prior order(s) from the customer database, loads the order(s) to screen with appropriate color-coding by order, and allows the customer the option of selecting the desired prior order or placing a new order. If a new order is selected, the thread will continue to Main. If customer selects a prior order, the customer is given the option to keep the prior order as is or to modify it. If the customer selects as is, and the customer identified with a credit or debit form of identification, the customer is provided the option to pay with the identification method or another way. If the customer opts to pay with the same card used for identification, the ordering process is completed, and the thread continues to ATM Cash or Card Status. If payment by another method is selected, the thread continues to Pay Method. If the customer wants to modify an order, the thread loads the order as if the customer had selected each item individually and continues to Main.

The Main screen consists of two main areas. One area contains buttons for menu categories. When a menu button is touched, the associated items are selected, and the thread continues to Items. The second area contains a list of items ordered and the pricing data for the entire order. To change an item, the item to be changed is touched in the list. When touched, the item is highlighted and additional buttons are displayed asking the customer if he wants to cancel change, delete item, or change item. If cancel change is selected, the thread continues. If delete item is selected, the thread deletes the selected item and associated sub items. If change item is selected, the thread displays the appropriate item module to allow the customer to change it.

At the Items screen, menu items of the type associated with a Menu Button are displayed. The Items screen allows the customer to select which of the category of items he wants. The thread continues to Condiments if the item selected has condiments, to Item Drink if the item is a drink, or to Item Special if other selections are required for the menu item, otherwise the thread continues to Item Quantity. For those items with condiments, the thread displays buttons to allow for the toggle selection of each condiment as Yes or No. The thread also allows for the selection of the quantity of that item and then continues to Main. For those items that do not have condiments or are not a drink, the screen displays buttons to allow the customer to select the quantity desired. The thread then continues to Main. For those items that are a drink, the thread displays buttons allowing the customer to select the size of drink and the quantity desired. The thread then continues to Main. The Item Special screen is used for those items that require additional information to completely specify which one by flavor, color, size, etc. At the Item Special screen, the thread displays buttons allowing the customer to enter the needed information. The thread then continues to Main. A Multi-Items screen is used for those items that actually comprise multiple sub items, such as value meals or similar combination meals. At this screen, the thread displays all of the previously selected sub items on the screen. The thread then allows the customer to select which sub item to change. When the sub item is selected, the thread continues to the associated Item module.

When the customer indicates that he has completed his order at the Main screen, the thread continues to the Pay Method screen. The thread displays a screen showing the amount of money required and allowing the customer to select cash or credit/debit payment. By inserting a coin, bill, or credit or debit card, the selected method of payment is indicated as to cash or payment card. If cash is selected, the thread continues to Cash Input. If credit/debit payment is selected, the thread continues to Card Read. At Cash Input, the screen displays the amount of cash required and the amount received. When the required amount is reached or exceeded, the thread determines the next action. If the exact amount is received, the thread continues to End Transaction. If change back is due, the thread continues to Cash Output.

If the customer opted for payment with a credit or debit card, the data is decoded from the card reader and parsed into fields. Specific fields are analyzed to determine a “good” read and what type of card was read. If a debit card is used, the thread continues to ATM Cash, otherwise the thread goes to Card Status. If customer is paying with a debit card, the thread displays the cash back option and notifies the customer of cash back availability for a transaction fee. The ATM Cash screen allows the customer to choose the desired cash back amount or none. Once this option is selected, the thread asks for customer to verify that he wants cash back for a transaction fee. If customer has selected ATM cash back, the thread displays information directing the customer to enter his pin code on the pin pad 24 and press enter. Once enter is pressed, the encrypted pin code is passed on to Card Status. Credit and debit card information is encrypted, along with the pin code if required, and transmitted to the modem. Credit or Debit card transaction status is returned from the modem. If the transaction is disapproved, the thread returns to Pay Method. If the transaction is approved, and cash back is required, the thread continues to Cash Output; otherwise, the thread continues to End Transaction.

When cash is due to the customer, the amount of cash to pay back is received by module in an integer variable. The variable is converted to coins required and that amount is transferred to the coin acceptor and dispenser dll. The variable is also converted to bills required and that amount is transferred to the bill dispenser dll. For customers due coin change back, they are automatically presented with a screen showing several charities. The customer is given the option of donating all of their coin change or just the pennies to one of the charities displayed. Alternatively, the customer may elect not to donate any of their change and so the change due back would round in favor of the customer to the nearest nickel if pennies are not used. Once the information is passed to the appropriate dll modules, the thread continues to End Transaction. The End Transaction screen displays information on the completed order and payment process and provides information such as an Order Number to the customer. The End Transaction screen also allows for the display of advertisements. The thread routes formatted data to the thermal printer 30, network, and database. After timing out, the thread resets order storage variables and returns to Welcome.

A PC 16 with Microsoft Windows runs the system through a program application. The system is connected to a telephone line for bankcard transactions and to a LAN or Inter-register Communication link for quick service restaurant 72 or 74 back office data transfer. Each order is sent via the LAN or Inter-register Communication link to the quick service restaurant's current system where it will be displayed on their order-picking screens 70. Status reporting and alerts are provided via the order-picking screens 70. That way, if coins run low or the printer 30 is low on paper 37, the need for replenishment is displayed where an employee will see it quickly. The system is designed to be Plug-n-Play compatible with a quick service restaurant's current system. For installation, a user will be able to unplug one of the current registers and plug in a terminal 10 of the present invention. Therefore, data is recorded and reported in the format currently in use at that restaurant 72 or 74. Operating system data is also recorded for analysis for product improvement.

The quick service restaurant 72 or 74 owner is responsible for keeping the coin acceptor and dispenser 18 and bill dispenser 22 filled with coins and bills respectively. The bill dispenser 22 has three bins for storing one's, five's, and twenty's. The twenty's are used for ATM cash back. The other two bins are for making change. The largest bill the bill verifier 20 will accept is a twenty. The coin acceptor and dispenser 18 has three tubes for storing nickels, dimes, and quarters. If a tube is partially full, inserted coins will be routed to the change tube. Otherwise, the coin will go to the coin box. The coin acceptor and dispenser 18 accepts Anthony and Sacajewea dollar coins. In the preferred embodiment, pennies are not accepted nor dispensed by the system. The cost of handling pennies is greater than they are worth. Four seconds of a minimum-wage employee's labor is equivalent to a penny. The cost of handling a penny, in and out, is almost equal to the labor cost of doing so. Everywhere you travel there is a cup with pennies in it sitting on the counter next to the register. Interestingly, many owners are enthusiastic about the idea of not using them. For payment by bankcard there will be no difference in the total price of an order. For cash payments, the amount due will be rounded down to the closest nickel. The quick service restaurant 72 or 74 owner can recoup the average of 2 cents lost on each cash transaction by raising the price of a commonly ordered item by 2 cents. It is of course understood that the system of the present invention may be equipped to accept and dispense pennies if desired.

The system allows a user to quickly and easily make changes and updates to a number of different terminals 10, even terminals 10 located in different restaurants 72 and 74. For example, menu item changes may be made via the telephone link by remote downloading. Each night the system will send the days diagnostic data and then download any changes. In this manner, a Franchiser can make a menu change overnight to all of their locations and be assured that the change is implemented. Each system will be linked electronically to the franchiser to receive pictures, descriptions, sales, promotions, etc.

Operating and maintenance changes can also be made locally by employees at the quick service restaurant 72 or 74. Screens to make such changes are available in a section of the program that is displayable only with a user name and password. Referring to FIG. 3, the screens that may be available include maintenance, service, price change, item status, and base information. The access level assigned to a password restricts what an employee can view or modify. From the maintenance screen, the status of each subsystem is displayed along with an error message if an item is not fully functional. Subsystems or components can also be tested. For example, to test the printer 30, a “Print” button would be touched and the printer 30 would print a test receipt. Likewise, a coin could be deposited and the system would identify what type of coin it is. In this way, all subsystems can be locally tested to assist in isolating and identifying a problem with the system. Subsystems can also be reinitialized without restarting the entire system from buttons located here.

A service screen shows the quantity by type of all currency in each subsystem and counters. The counts can be changed as required to reflect replenishment of coin tubes or bill bins. A price change screen allows for the selection of an item and subsequent changing of the price. For products that are out of stock, an item status screen allows for the selection and changing of each menu item into 1 of 4 categories:

fully available—displayed normally

“Temporarily Unavailable”—shown with these words across button, cannot select

“Not Available This Location”—shown with these words across button, cannot select

not available—not displayed

The system logs a variety of activities. For changes made to the system locally through the software, all activity is logged from the beginning of entry of the user name until exiting of the change modules. All changes in subsystem status are logged. Other activity can be logged as requested by the customer or as required to analyze the system to improve operation.

The terminal 10 provides great flexibility in maintenance and repair. Self-diagnostic software is automatically run at desired intervals and can self-identify many problems and report them via electronic message to a central location 78. In this manner, it will be known as soon as the event occurs so that corrective action can be initiated. The error will be analyzed for appropriate action. Either the help desk will call the quick service restaurant 72 or 74 with self-help instructions or a repair part will be express shipped overnight to the quick service restaurant 72 or 74. If on-site repair is needed, maintenance will issue a dispatch order to the closest service point.

As best seen in FIG. 3, the following is a sample “thread” that an employee might go through during onsite maintenance or service. The Password screen displays a numeric keypad for entry of an employee number. Once a correct number is entered, the thread displays a keyboard for entry of employee password. If the password matches the employee number entered, the thread displays buttons allowing to the employee to select maintenance or service. Based on the button selected, the thread continues to Maintenance or Service. If an incorrect password is entered, the thread continues to Main.

Based on the access level granted to the employee, the thread displays various buttons and data. Depending upon the authorization level of the employee, the Maintenance screen may display the overall system status and the status of each subassembly. The Maintenance screen may also provide for the reinitializing and testing of each subassembly. The Maintenance screen may also display system data as it occurs and may log malfunctions. The system can be shut down from here. Buttons allow for return to Welcome or to Service.

Based on the access level granted the employee, the Service screen displays various buttons and data. The Service screen may display the coin and bill counters, input and output. The Service screen may summarize currency data by category and may allow for the changing and resetting of counters. The Service screen may also allow for the changing of prices and item availability. Buttons also allow for return to Welcome or to Maintenance.

The present system combines the features of audio-visual media presentation with those of self-service terminals to create a new and very efficient device for the promotion and sale of products and services, for the subsequent completion of the payment transaction, for the offering of ATM cash back capability during either the order process or separately, and for the automatic updating of stored data, malfunction reporting and diagnosis, and data collection transfer for reporting and analysis. The system provides for fast, efficient order placement and makes it easy for a customer to place an order that is the same as or similar to that customer's earlier orders. The self-diagnostic software and system of alerts reduce downtime and simplify maintenance and repair. The use of a number of different security zones and authorization levels also simplifies routine maintenance and restocking chores while providing safeguards to restrict access to coins, bills, and system data.

Other modifications, changes, and substitutions are intended in the foregoing, and in some instances, some features of the invention will be employed without a corresponding use of other features. It is understood that the subassemblies or components mentioned may be used or omitted in any number of different combinations. For example, ATM capabilities may or may not be used. Also, a single computer 16 may be used to control any number of terminals, and other components such as the coin acceptor and dispenser 18, bill verifier 20, and bill dispenser 22 may be shared by a number of different terminals. Particularly if the terminal is used outside the restaurant as part of a drive through station, the terminal may be used simply for order placement functions and may not be equipped to accept payment, return change, or provide ATM services. The components and subassemblies specifically mentioned are by way of example and are not intended as an exhaustive listing of the components or subassemblies that might be included as part of a terminal 10 or as part of an overall system. Of course, the placement and arrangement of the various components within a terminal 10 housing 12 may also take any number of configurations. Further, although a touch screen display is preferred, any conventional method of data entry may be used, including but not limited to keypads, keyboards, voice recognition software, and the like. Further still, the arrangements and ordering of the specific screens and threads are intended as examples only. It is understood that any number of different screens and threads may be used. Of course, quantitative information is included by way of example only and is not intended as a limitation as to the scope of the invention. Accordingly, it is appropriate that the invention be construed broadly and in a manner consistent with the scope of the invention disclosed.

What is claimed is:

1. A method, comprising:
(1) providing at least one order entry station having at least one display at at least one restaurant;
(2) having a customer enter an identification code at said at least one station;
(3) having said customer enter a first order at said at least one station;
(4) accepting payment for and fulfilling said first order;
(5) after step (4), having said customer enter said identification code at said at least one station;
(6) after step (5), displaying said first order on said at least one display;
(7) after step (6), allowing said customer an option of entering a second order at said at least one station that is identical to said first order.

2. The method of claim 1, wherein step (7) comprises:
after step (6), allowing said customer an option of entering said second order at said at least one station that is identical to said first order by making a one or two keystroke selection.

3. The method of claim 1, wherein step (7) comprises:
after step (6), allowing said customer an option of entering said second order at said at least one station, said second order being identical to or different from said first order; and further comprising:
(8) accepting payment for and fulfilling said second order;
(9) after step (8), having said customer enter said identification code at said at least one station;
(10) after step (9), displaying said first order and said second order on said at least one display; and
(11) after step (10), allowing said customer an option of entering a third order at said at least one station that is identical to said first order or said second order.

4. The method of claim 3, wherein step (10) comprises, after step (9), displaying said first order on a first background and said second order on a second background on said at least one display, said first background being visually different from said second background.

5. The method of claim 4, wherein said first order is selected from a breakfast menu and said second order is selected from a lunch menu.

6. The method of claim 3, wherein step (10) comprises, after step (9), displaying said first order on said first background and said second order on said second background on said at least one display, said first background being a first color and said second background being a second color, said first and second colors being different.

7. The method of claim 1, wherein said at least one order entry station having at least one display comprises a first order entry station having a first display and a second order entry station having a second display, and wherein:
step (2) comprises, having said customer enter said identification code at said first station;
step (3) comprises, having said customer enter said first order at said first station;
step (5) comprises, after step (4), having said customer enter said identification code at said second station;
step (6) comprises, after step (5), displaying said first order on said second display; and
step (7) comprises, after step (6), allowing said customer an option of entering said second order at said second station that is identical to said first order.

8. The method of claim 7, wherein said at least one restaurant comprises first and second restaurants, and wherein step (1) comprises providing said first order entry station having said first display at said first restaurant and providing said second order entry station having said second display at said second restaurant.

9. The method of claim 8 wherein step (7) comprises:
after step (6), allowing said customer an option of entering said second order at said second station that is identical to said first order by making a one or two keystroke selection.

10. The method of claim 7, further comprising:
providing a remote database for storing and supplying data relating to said first order; electronically providing said data relating to said first order from said first station to said remote database; and
electronically providing said data relating to said first order from said remote database to said second order entry station.

11. The method of claim 1, wherein:
step (1) comprises providing said at least one order entry station having said at least one display in said at least one restaurant, said at least one order entry station having self-diagnostic software capable of generating an error report; and further comprising:
automatically running said self-diagnostic software at desired intervals to determine whether said error report should be generated;
if said error report is generated, automatically and electronically providing said error report to a remote receiver.

12. A method, comprising:
(1) providing a self-service food order entry station having a first display at an order placement area of a food service location, said station having at least one currency storage bin storing currency for making change;
(2) providing a second display at a food preparation area of said food service location;
(3) having a customer enter an order on, make payment to, and receive change from said station;
(4) displaying data from said order on said second display; and
(5) displaying a low currency indicator on said second display when a value of said currency in said currency storage bin falls below a desired amount.

13. The method of claim 12, wherein:
step (1) comprises providing a self-service food order entry station having a first display at an order placement area of a food service location, said station having at least one currency storage bin storing currency for making change and said station having sheet material for providing a receipt; and
further comprising displaying a low sheet material indicator on said second display when an amount of said sheet material in said station falls below a desired level.

14. The method of claim 13, further comprising:
providing a first locking means having a first unlocking means for restricting access to said sheet material; and
providing a second locking means having a second unlocking means for restricting access to said at least one currency storage bin, said second unlocking means being different from said first unlocking means.

15. A combination, comprising:
a housing;
a display disposed in said housing;
a coin dispenser disposed in said housing;
a coin dispenser lock having a first unlocking means for restricting access to coins in said coin dispenser;
a bill dispenser disposed in said housing;
a bill dispenser lock having a second unlocking means for restricting access to bills in said bill dispenser;
a printer disposed in said housing; and
a printer lock having a third unlocking means for restricting access to said printer, said first, second, and third unlocking means being different.

16. The combination of claim 15, further comprising:
a bill acceptor and verifier disposed in said housing; and
a bill acceptor and verifier lock having a fourth unlocking means for restricting access to bills in said bill acceptor and verifier, said fourth unlocking means and said second unlocking means being the same.

17. The combination of claim 15, further comprising:
a first rail disposed in said housing, said coin dispenser being slidably secured to said first rail; and
a second rail disposed in said housing, said bill dispenser being slidably secured to said second rail.

18. The combination of claim 17, further comprising:
a third rail disposed in said housing, said printer being slidably secured to said third rail.

19. The combination of claim 15, further comprising:
a data storage device disposed within said housing; and
a database with customer order data stored in said data storage device.

20. 7he combination of claim 19, further comprising:
a first remote access device coupled to said data storage device;
a remote database for storing and supplying said customer order data;
a second remote access device coupled to said remote database; and
means for automatically and electronically providing said customer order data from said database to said remote database.
